(19) United States
(12) Patent Application Publication
(10) Pub. No.: US 2026/0280917 A1
(43) Pub. Date: Sep. 17, 2026

(54) SCHEDULE PERMISSION CONFIGURING METHOD AND APPARATUS, ELECTRONIC DEVICE, AND STORAGE MEDIUM

(71) Applicant: Beijing Zitiao Network Technology Co., Ltd., Beijing (CN)

(72) Inventor: Lizhu CAO, Beijing (CN)

(21) Appl. No.: 18/877,855

(22) PCT Filed: Nov. 15, 2023
(86) PCT No.: PCT/CN2023/131816

§ 371 Date: Dec. 20, 2024

(30) Foreign Application Priority Data
Nov. 24, 2022 (CN) 202211486206.0

(51) Int. Cl. H04L 12/18

(52) U.S. Cl. CPC H04L 12/1818; H04L 12/1822

(57) ABSTRACT

The present disclosure provides a schedule permission configuring method and apparatus, and an electronic device. The method comprises: displaying a permission configuration prompt message in response to detecting a preset trigger event; and configuring a schedule permission in response to an operation of performing schedule permission configuration. According to the method provided in the present disclosure, when the preset trigger event is detected, a user may be reminded in a timely manner to configure the schedule permission, to prevent schedule order management from being threatened due to untimely configuration of the schedule permission. This improves the efficiency of schedule order management and reduces schedule risks, thereby enhancing the schedule experience of the user.

### CROSS-REFERENCE TO RELATED APPLICATIONS

The present application is based on and claims priority to Chinese Patent Application No. 202211486206.0, filed on Nov. 24, 2022, and entitled “SCHEDULE PERMISSION CONFIGURING METHOD AND APPARATUS, ELECTRONIC DEVICE, AND STORAGE MEDIUM”, the disclosure of which is incorporated herein by reference in its entirety.

### TECHNICAL FIELD

The present disclosure relates to the field of computer technologies, and in particular, to a schedule permission configuring method and apparatus, an electronic device, and a storage medium.

### BACKGROUND

With the rapid development of the Internet and multimedia technologies, multimedia meetings such as audio meetings and video meetings with good real-time performance and interactivity have been widely used. For a multimedia meeting, in some scenarios, the need to manage meeting permissions (such as a speaking permission and a sharing permission) is prominent. If the meeting permissions are not properly managed, there may be uninvited users joining the meeting, disrupting the meeting order and threatening the meeting security.

In the related art, meeting permissions of attendees are often set and managed by a host consciously and actively. However, when the number of the attendees is large or the host is inexperienced, the meeting permissions of the attendees often cannot be managed in a timely manner, resulting in poor efficiency of meeting order management.

### SUMMARY

According to an aspect of the present disclosure, there is provided a schedule permission configuring method, where the method includes: displaying a permission configuration prompt message in response to detecting a preset trigger event; and configuring a schedule permission in response to an operation of performing schedule permission configuration.

According to another aspect of the present disclosure, there is provided a schedule permission configuring method, where the method includes: receiving schedule progress information from a client; and determining, based on the schedule progress information, that a preset trigger event occurs on the client, and configuring a schedule permission based on a recommended permission configuration policy.

According to another aspect of the present disclosure, there is provided a schedule permission configuring apparatus, where the apparatus includes: a display module configured to display a permission configuration prompt message in response to detecting a preset trigger event; and a configuration module configured to configure a schedule permission in response to an operation of performing schedule permission configuration.

According to another aspect of the present disclosure, there is provided a schedule permission configuring apparatus, where the apparatus includes: a communication module configured to receive schedule progress information from a client; and a configuration module configured to determine, based on the schedule progress information, that a preset trigger event occurs on the client, and configure a schedule permission based on a recommended permission configuration policy.

According to another aspect of the present disclosure, there is provided an electronic device, including: a processor; and a memory storing a program; where the program includes instructions that, when executed by the processor, cause the processor to perform the method according to an exemplary embodiment of the present disclosure.

According to another aspect of the present disclosure, there is provided a non-transitory computer-readable storage medium storing computer instructions, where the computer instructions are used to cause a computer to perform the method according to an exemplary embodiment of the present disclosure.

According to one or more technical solutions provided in the exemplary embodiments of the present disclosure, the permission configuration prompt message may be displayed when the preset trigger event is detected, and the displayed permission configuration prompt message may remind a user in a timely manner to configure the current schedule permission. On this basis, the current schedule permission may be configured in response to a configuration operation for the current schedule permission. It can be learned that, according to the method in the exemplary embodiment of the present disclosure, the user is reminded in a timely manner to configure the schedule permission when the preset trigger event is detected, thereby improving the efficiency of schedule management, and avoiding the occurrence of schedule disorder caused by untimely configuration of the schedule permission.

### BRIEF DESCRIPTION OF THE DRAWINGS

Further details, features and advantages of the present disclosure are disclosed in the following description of exemplary embodiments in conjunction with the accompanying drawings, in which:

FIG. 1 is a schematic diagram of an example system, in which various methods described herein may be implemented, according to exemplary embodiments of the present disclosure;

FIG. 2 is an exemplary flowchart of a schedule permission configuring method according to exemplary embodiments of the present disclosure;

FIG. 3A is a schematic diagram of a schedule creation page according to exemplary embodiments of the present disclosure;

FIG. 3B is a schematic diagram of a schedule control terminal interface according to exemplary embodiments of the present disclosure;

FIG. 3C is a schematic diagram of a schedule creation page with a permission configuration prompt message dismissed according to exemplary embodiments of the present disclosure;

FIG. 4A is a schematic diagram of a schedule creation notification according to exemplary embodiments of the present disclosure;

FIG. 4B is a schematic diagram of a permission enabled notification according to exemplary embodiments of the present disclosure;

FIG. 5 is a schematic diagram of a display manner of a permission configuration prompt message in a display interface according to exemplary embodiments of the present disclosure;

FIG. 6A is a first schematic diagram of a permission configuration interface according to exemplary embodiments of the present disclosure;

FIG. 6B is a second schematic diagram of a permission configuration interface according to exemplary embodiments of the present disclosure;

FIG. 6C is a third schematic diagram of a permission configuration interface according to exemplary embodiments of the present disclosure;

FIG. 7 is another exemplary flowchart of a schedule permission configuring method according to an exemplary embodiment of the present disclosure;

FIG. 8 is a schematic block diagram of modules of a schedule permission configuring apparatus according to exemplary embodiments of the present disclosure;

FIG. 9 is another schematic block diagram of modules of a schedule permission configuring apparatus according to exemplary embodiments of the present disclosure;

FIG. 10 is a schematic block diagram of a chip according to exemplary embodiments of the present disclosure; and

FIG. 11 is a block diagram of a structure of an exemplary electronic device that can be used to implement embodiments of the present disclosure.

### DETAILED DESCRIPTION

The embodiments of the present disclosure are described in more detail below with reference to the accompanying drawings. Although some embodiments of the present disclosure are shown in the accompanying drawings, it should be understood that the present disclosure may be implemented in various forms and should not be construed as being limited to the embodiments set forth herein. Rather, these embodiments are provided for a more thorough and complete understanding of the present disclosure. It should be understood that the accompanying drawings and the embodiments of the present disclosure are only for exemplary purposes, and are not intended to limit the scope of protection of the present disclosure.

It should be understood that the various steps described in the method implementations of the present disclosure may be performed in different orders, and/or performed in parallel. Furthermore, additional steps may be included and/or the execution of the illustrated steps may be omitted in the method implementations. The scope of the present disclosure is not limited in this respect.

The term “include/comprise” used herein and the variations thereof are an open-ended inclusion, namely, “include/comprise but not limited to”. The term “based on” is “at least partially based on”. The term “an embodiment” means “at least one embodiment”. The term “another embodiment” means “at least one another embodiment”. The term “some embodiments” means “at least some embodiments”. Related definitions of the other terms will be given in the description below. It should be noted that concepts such as “first” and “second” mentioned in the present disclosure are only used to distinguish different apparatuses, modules, or units, and are not used to limit the sequence of functions performed by these apparatuses, modules, or units or interdependence.

It should be noted that the modifiers “one” and “a plurality of” mentioned in the present disclosure are illustrative and not restrictive, and those skilled in the art should understand that unless the context clearly indicates otherwise, the modifiers should be understood as “one or more”.

The names of messages or information exchanged between a plurality of apparatuses in the implementations of the present disclosure are used for illustrative purposes only, and are not used to limit the scope of these messages or information.

Before describing the embodiments of the present disclosure, the following definitions are given for relevant terms involved in the embodiments of the present disclosure:

Schedule refers to a plan and arrangement for a specific time node or period such as a day, a week, or a month. The schedule may be implemented in various possible forms such as a video meeting, a voice call, and text communication. In this case, the schedule may be a meeting schedule. Taking a common network meeting as an example, a meeting initiator may create a network meeting by adding attendees and scheduling a meeting time period, and send a network meeting link to the attendees. When a scheduled meeting start time is reached, the attendees enter the schedule by clicking on the network meeting link, scanning a schedule invitation code, and entering a schedule number to enter a network meeting room, to attend the meeting.

When a speaker is speaking, if speaking permissions of other attendees are not managed timely, the meeting room may be noisy and the speaker's voice cannot be heard clearly. For another example, when the speaker is sharing a file, if sharing permissions of other attendees are not managed timely, a sharing screen may be occupied and the meeting may be interrupted. On this basis, during proceeding of the schedule, some uninvited users often join the schedule, and turn on microphones, chat, share files and alter labels at will. This disrupts schedule order management and threatens the schedule security.

In the related art, to manage the meeting order, administrators need to set and manage meeting permissions of attendees consciously and actively. However, a host needs to set the meeting permissions consciously, and the meeting permissions of the attendees often cannot be managed in a timely manner, resulting in poor efficiency of schedule order management.

The inventors found that when the number of attendees increases, the proportion of the attendees whose meeting permissions (such as speaking permission and sharing permission) need to be managed also increases, such that it is relatively difficult to manage the schedule order. On this basis, in order to solve the technical problem of poor efficiency of schedule order management caused by untimely management of the meeting permissions of the attendees, an exemplary embodiment of the present disclosure provides a schedule permission configuring method. According to the method, a user may be reminded in a timely manner to configure a schedule permission when a preset trigger event is detected, to prevent schedule order management from being threatened due to untimely configuration of the schedule permission. This improves the efficiency of schedule management and therefore enhances the schedule experience of the user.

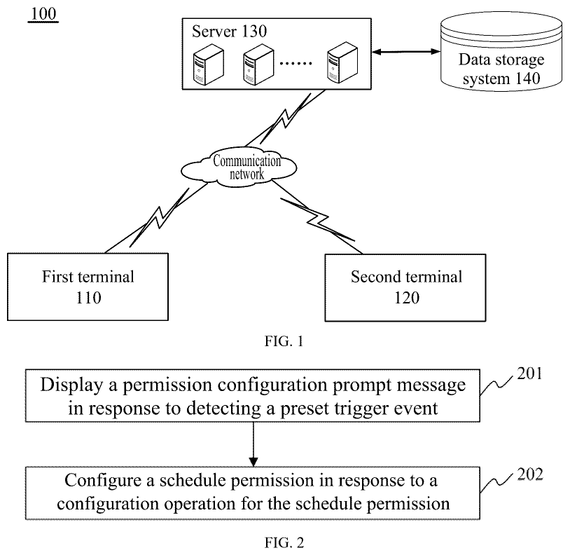

The schedule permission configuring method according to the exemplary embodiment of the present disclosure may be applied to various scenarios that can be used to configure schedule permissions. FIG. 1 is a schematic diagram of an example system, in which various methods described herein may be implemented, according to an exemplary embodiment of the present disclosure. As shown in FIG. 1, an application scenario 100 in the exemplary embodiment of the present disclosure includes a first terminal 110, a second terminal 120, a server 130, and a data storage system 140.

In practical application, as shown in FIG. 1, the first terminal 110 and the second terminal 120 are both installed with a client that can participate in a schedule, and may further be installed with other clients. It should be understood that the client herein may be any client that can participate in a schedule, including a schedule client, a live streaming client, a chat website, and the like, which are not listed one by one herein.

The clients installed on the first terminal 110 and the second terminal 120 may be the same type of applications that are based on the same or different operating system platforms (Android, iOS, Huawei HarmonyOS, and the like). The first terminal 110 may be a terminal that initiates a schedule. The second terminal 120 may be a target terminal corresponding to another user who participates in the schedule. There may be one or more second terminals 120, which is determined based on an actual application scenario. The exemplary embodiment of the present disclosure is only illustrated by using the first terminal 110 and the second terminal 120 as an example. The device types of the first terminal 110 and the second terminal 120 are the same or different. The device types include: at least one of a smartphone, a tablet computer, a laptop computer, and a desktop computer.

As shown in FIG. 1, the first terminal 110 and the second terminal 120 described above may communicate with the server 130 through a communication network. In terms of communication modes, the communication network may be a wireless communication network, such as satellite communication and microwave communication, or may be a wired communication network such as fiber optic communication and power line carrier communication. In terms of communication ranges, the communication network may be a local area communication network, such as WiFi and a Zigbee communication network, or may be a wide area communication network, such as the Internet.

As shown in FIG. 1, the above server 130 may be a single server, or may be a server cluster or a distributed system that is composed of a plurality of servers, or may be a cloud server that provides basic cloud computing services such as cloud services, cloud databases, cloud computing, cloud functions, cloud storage, network services, cloud communication, middleware services, domain name services, security services, content delivery networks (CDNs), and big data and artificial intelligence platforms. The data storage system 140 may be a general term, including a local storage and a database for storing historical data. The data storage system 140 may be separate from the server 130 or may be integrated into the server 130.

In practical application, a user corresponding to the first terminal 110 is a first user, and the first user is a schedule initiating user. A user corresponding to the second terminal 120 is a second user, and the second user is a schedule participating user. The first user and the second user may enter their own user names and passwords through the first terminal 110 and the second terminal 120 respectively, to log in to the server 130. The server 130 verifies identities of the users by reading a user database. If the user name and the password are both correct, a sign that the user logged in successfully is displayed. The first user may pull at least one second user into a meeting room through group chatting to start a schedule, or the first user and the second user may enter a meeting room to participate in a schedule by clicking on a schedule link, scanning a schedule invitation code, entering a schedule number, and the like.

The first user may configure a schedule permission in a permission configuration interface of the first terminal 110. The first terminal 110 configures the schedule permission in response to a configuration operation of the user for the schedule permission, to obtain schedule permission configuration information. Then, the first terminal 110 sends the schedule permission configuration information to the server 130. The server 130 sends the schedule permission configuration information to the second terminal 120. After receiving the schedule permission configuration information, the second terminal 120 configures the schedule permission based on the schedule permission configuration information. In addition, the schedule permission may alternatively be configured on the server 130. The server 130 sends the configured schedule permission configuration information to the first terminal 110 and the second terminal 120. After receiving the schedule permission configuration information, the first terminal 110 and the second terminal 120 configure the schedule permission based on the schedule permission configuration information.

In the method in the exemplary embodiment of the present disclosure, when a preset trigger event is detected, the configuration operation for the schedule permission may be performed on the client or on the server. When the configuration operation for the schedule permission is performed on the client, a permission configuration prompt message for the preset trigger event may be directly displayed by the client, or a permission configuration prompt message may be received from the server and then displayed.

When the configuration operation for the schedule permission is performed on the client, the schedule permission configuring method in the exemplary embodiment of the present disclosure may be performed by the client. In the exemplary embodiment of the present disclosure, the client may be a schedule client (a multimedia meeting terminal), or a schedule control terminal (a control terminal that is used to control a multimedia meeting), which is not specifically limited herein. FIG. 2 is an exemplary flowchart of a schedule permission configuring method according to an exemplary embodiment of the present disclosure. As shown in FIG. 2, the schedule permission configuring method in the exemplary embodiment of the present disclosure may include:

Step 201: Display a permission configuration prompt message if a preset trigger event is detected. In the exemplary embodiment of the present disclosure, the schedule may be a meeting schedule, and the occasion for detecting the preset trigger event may be before the meeting schedule starts or during the meeting schedule.

The above preset trigger event may support configuration and update. In other words, the preset trigger event may be configured flexibly based on an actual schedule scenario. In this case, given that the preset trigger event that triggers schedule permission control may be different in different schedule scenarios, the preset trigger event that has been configured may be updated, such that the updated preset trigger event conforms to a current schedule scenario. Therefore, according to the exemplary embodiment of the present disclosure, diverse control on a schedule permission may be implemented by flexibly configuring the preset trigger event, such that the schedule permission is more adaptable to the current schedule scenario, thereby improving the efficiency of schedule management.

Step 202: Configure a schedule permission in response to a configuration operation for the schedule permission. A user may configure the schedule permission based on recommended permission configuration information in a permission configuration interface, such that the configured schedule permission matches a recommended permission policy, potential risks during proceeding of the schedule are reduced, and the schedule security is ensured. It should be understood that the user herein may be a schedule creator, a schedule host, or a co-host, or may be one or several designated users. The above configuration for the schedule permission may be configuration for a specific schedule permission or configuration for a plurality of schedule permissions.

It can be learned that, according to the method provided in the exemplary embodiment of the present disclosure, the permission configuration prompt message may be displayed when the preset trigger event is detected. The displayed permission configuration prompt message may remind the user in a timely manner to configure the current schedule permission. On this basis, the current schedule permission may be configured in response to a configuration operation for the current schedule permission. It can be learned that, according to the method in the exemplary embodiment of the present disclosure, the user may be reminded in a timely manner to configure the schedule permission when the preset trigger event is detected, thereby improving the efficiency of schedule management, reducing schedule risks, and avoiding the occurrence of schedule disorder caused by untimely configuration of the schedule permission.

In an optional implementation, the above step 201 may include: displaying the permission configuration prompt message in a client interface of a first user having a schedule configuration permission if the preset trigger event is detected, such that the first user and/or a second user designated by the first user configures a schedule permission. It should be understood that the first user is a user having the schedule configuration permission, and may be a schedule creator or a schedule host. The second user may be a co-host, another schedule attendee, a schedule control terminal, or a server designated by the first user. The second user also has the schedule configuration permission, but authorization from the first user is needed for validity of the schedule configuration permission of the second user.

For example, in a teaching scenario, when a preset trigger event is detected, a permission configuration prompt message pops up in a client interface of a teacher. If the teacher directly performs permission configuration, class progress may be interrupted. In this case, the teacher may grant a schedule configuration permission to a co-host or another user in the form of a notification, such that the co-host or the another user performs schedule permission configuration. The teacher may alternatively send a schedule permission configuration instruction to a schedule control terminal or a server, to request the schedule control terminal or the server to configure a schedule permission. It can be learned that in the method in the exemplary embodiment of the present disclosure, the first user may grant the schedule configuration permission to the second user, and the schedule permission configuration is implemented by the second user, such that the schedule security can be improved without disturbing the schedule progress.

In an optional implementation, the above preset trigger event may include at least one of the following: the number of schedule attendees is greater than or equal to a preset number, an attendee with a preset identity is present among the schedule attendees, a schedule attribute is a preset schedule attribute, a permission state does not match a recommended permission configuration policy, and the number of display times of the permission configuration prompt message is less than a preset number of times.

When the preset trigger event includes that the number of the schedule attendees is greater than or equal to the preset number, the preset number may be a preset number of schedule attendees. The preset number may be a preset number of schedule attendees recommended by the client, or a preset number of schedule attendees determined by the user based on experience, or a preset number of schedule attendees determined by the user based on the needs of a schedule scenario. This is specifically determined based on the actual application scenario and is not limited herein. In the same schedule, when the number of the schedule attendees is greater than or equal to the preset number, the problem of schedule disorder may occur. Therefore, when it is detected that the number of the schedule attendees is greater than or equal to the preset number, the displayed permission configuration prompt message may remind the user in a timely manner to configure a current schedule permission. This reduces schedule risks and avoids the occurrence of schedule disorder caused by untimely configuration of the schedule permission.

To facilitate the understanding of an implementation process of the method in the exemplary embodiment of the present disclosure, the implementation process of the method in the exemplary embodiment of the present disclosure is described below in conjunction with the accompanying drawings. It should be understood that the following implementation process is intended merely for explanation and not restrictive.

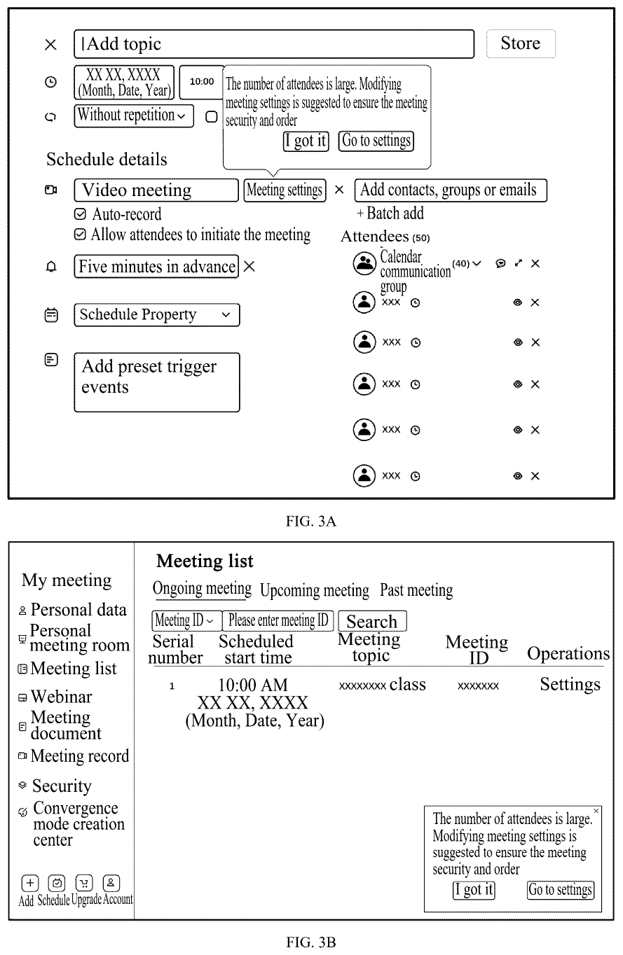

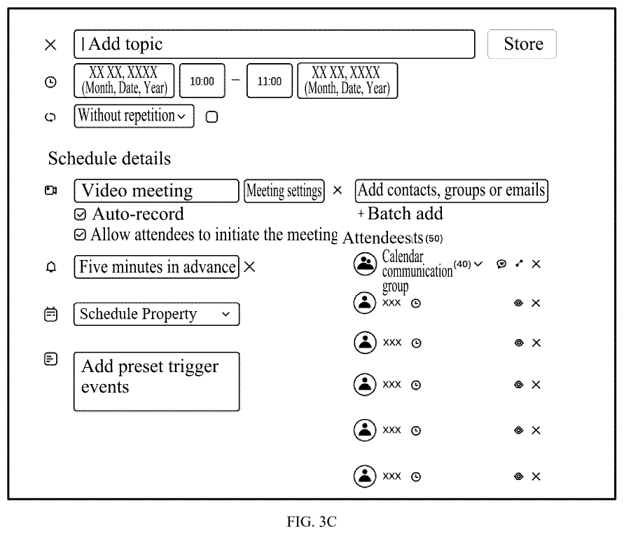

FIG. 3A is a schematic diagram of a schedule creation page according to an exemplary embodiment of the present disclosure. As shown in FIG. 3A, after the addition of schedule attendees is completed in a schedule creation page, when a schedule client detects that the number of the schedule attendees is greater than or equal to 40, a floating box may be displayed at “Meeting settings”, and a permission configuration prompt message, for example, “The number of attendees is large. Modifying meeting settings is suggested to ensure the meeting security and order”, may be displayed in the floating box to remind a user of the schedule client to perform permission configuration.

FIG. 3B is a schematic diagram of a schedule control terminal interface according to an exemplary embodiment of the present disclosure. As shown in FIG. 3B, when a schedule control terminal detects that the number of schedule attendees is greater than or equal to 40, a pop-up window may be displayed in a schedule control terminal interface. A permission configuration prompt message, for example, “The number of attendees is large. Modifying meeting settings is suggested to ensure the meeting security and order”, may be displayed in the pop-up window to remind a user of the schedule control terminal to perform permission configuration.

When the preset trigger event includes that the attendee with the preset identity is present among the schedule attendees, the schedule attendee may be a friend user of a schedule client, or a user who is searched through email, or a user member in other schedules, which is specifically determined based on an actual application scenario and is not limited herein. The preset identity may be a user in a preset position or a customized preset user. When the attendee with the preset identity is present among the schedule attendees, the content of the schedule is generally highly private. Therefore, when it is detected that the attendee with the preset identity is present among the schedule attendees, the displayed permission configuration prompt message may remind the user in a timely manner to configure a current schedule permission, to further improve a security level of the schedule, thereby ensuring the privacy of the schedule content and reducing a risk of schedule content leakage.

For example, when schedule attendees are added within the schedule creation page shown in FIG. 3A, since the schedule attendees often carry identity identifiers, when it is detected that an attendee with an identity identifier of “Senior executive” is present among the schedule attendees, a floating box may be displayed at “Meeting settings”. A permission configuration prompt message, for example, “The number of attendees is large. Modifying meeting settings is suggested to ensure the meeting security and order”, may be displayed in the floating box to remind the user to perform permission configuration.

When the preset trigger event includes that the schedule attribute is the preset schedule attribute, the schedule attribute may be determined based on a schedule topic name, or may be selected in a drop-down box or newly added when the schedule is created. The preset schedule attribute may be one of a class scenario, a live streaming meeting scenario, a webinar, and another customized scenario whose security level needs to be enhanced. When the schedule attribute is the preset schedule attribute, the number of schedule attendees included in the schedule is relatively large, schedule disorder is prone to occur, and great adverse impact is caused by the schedule disorder. For example, an uninvited user invades a class, seizes a speaking permission and sharing permission of a teacher, turns on a microphone, chats, shares files and alters labels at will. This disrupts class order management and threatens the class security. Therefore, when it is detected that the schedule attribute is the preset schedule attribute, the displayed permission configuration prompt message may remind the user in a timely manner to configure a current schedule permission, to further manage the schedule permission, thereby ensuring the schedule order and reducing schedule risks.

For example, when a schedule topic name is added within the schedule creation page shown in FIG. 3A, the schedule topic name may be detected. If the directivity of the schedule topic name is relatively clear, for example, “XXXXX Class”, in this case, it may be determined that the schedule attribute of the schedule is “class”. If the directivity of the schedule topic name is unclear, for example, “Determine the content of XXXX online after ten minutes”, in this case, the schedule attribute cannot be determined, and the schedule attribute may be selected in a schedule attribute drop-down box of the schedule creation page, or the schedule attribute may be customized and added in the schedule attribute drop-down box. After the schedule attribute is determined, if it is detected that the schedule attribute is the preset class attribute, a floating box may be displayed at “Meeting settings”. A permission configuration prompt message, for example, “The meeting attribute is the preset attribute. Modifying meeting settings is suggested to ensure the meeting security and order”, may be displayed in the floating box to remind the user to perform permission configuration.

When the preset trigger event includes that the permission state does not match the recommended permission configuration policy, the recommended permission configuration policy satisfies the following: The permission state of the schedule permission satisfies a recommended permission state, where the recommended permission state is used to manage the schedule permission. If the permission state of the schedule attendee matches the corresponding recommended permission state, the risk during proceeding of the schedule is low, such that normal operation of the schedule can be ensured, it is unnecessary to reconfigure the permission state of the schedule permission, and the permission state of the schedule permission continues to be maintained. For example, for an “Auto-mute when joining the meeting” permission of the schedule attendee, a recommended permission state of the “Auto-mute when joining the meeting” permission is on. If a current permission state of the “Auto-mute when joining the meeting” permission is on, the current permission state of the “Auto-mute when joining the meeting” permission matches the recommended permission state. In this case, it is unnecessary to reconfigure the “Auto-mute when joining the meeting” permission, and the “Auto-mute when joining the meeting” permission continues to be on. If the permission state of the schedule attendee does not match the corresponding recommended permission state, the permission state of the schedule permission is reconfigured such that the permission state of the schedule permission matches the corresponding recommended permission state. For example, if a current permission state of the “Auto-mute when joining the meeting” permission is off, the current permission state of the “Auto-mute when joining the meeting” permission does not match the recommended permission state. In this case, it is necessary to reconfigure the “Auto-mute when joining the meeting” permission, and the permission state of the “Auto-mute when joining the meeting” permission is configured to be on. Therefore, when it is detected that the permission state does not match the recommended permission configuration policy, the permission configuration prompt message is displayed to remind the user in a timely manner to configure the permission state of the corresponding schedule permission based on the recommended permission configuration policy, such that the permission state of the schedule permission matches the recommended permission configuration policy, thereby improving the efficiency of schedule order management and reducing schedule risks.

When the preset trigger event includes that the number of display times of the permission configuration prompt message is less than the preset number of times, the preset number of times may be one or more times. When the preset number of times is once, if at least one of the above preset trigger events (the number of the schedule attendees is greater than or equal to the preset number, the attendee with the preset identity is present among the schedule attendees, the schedule attribute is the preset schedule attribute, and the permission state does not match the recommended permission configuration policy) is detected, the user may be reminded in a timely manner to configure a schedule permission. This improves the efficiency of schedule order management and reduces schedule risks. When the preset number of times is a plurality of times, if at least one of the above preset trigger events is detected, the user may be reminded at intervals to configure a schedule permission, to prevent the user from forgetting to manage the schedule permission after receiving the permission configuration prompt message and to prevent an event threatening the schedule security.

In practical application, the number of display times of the permission configuration prompt message may be recorded. If at least one of the above preset trigger events (the number of the schedule attendees is greater than or equal to the preset number, the attendee with the preset identity is present among the schedule attendees, the schedule attribute is the preset schedule attribute, and the permission state does not match the recommended permission configuration policy) is detected, it may be first determined whether the number of display times of the permission configuration prompt message is less than a preset number of times. If the number of display times is less than the preset number of times, it means that the permission configuration prompt message has not been displayed to the user during proceeding of the schedule, or the user has not performed a configuration operation for the permission configuration prompt message, and the permission configuration prompt message may be displayed. Otherwise, it means that the user has configured the schedule permission, and the permission configuration prompt message will not be displayed later. Alternatively, the permission configuration prompt message has been known by the user and may not be display again.

When it is determined that the number of display times of the permission configuration prompt message is less than the preset number of times, it may be further determined whether at least one of the other four preset trigger events described above is detected. If at least one of the above preset trigger events is detected, the permission configuration prompt message may be displayed. If one of the other four preset trigger events described above is detected, it may be further determined whether other preset trigger events occur, to more comprehensively determine whether to display the permission configuration prompt message to the user. This avoids displaying the permission configuration prompt message a plurality of times during proceeding of the schedule and thus avoids interrupting the schedule, thereby improving the schedule experience of the user.

It should be noted that in the exemplary embodiment of the present disclosure, FIG. 3A and FIG. 3B illustrate only an example of the permission configuration prompt message when the preset trigger event is that the number of the schedule attendees is greater than or equal to the preset number. It can be understood that in some application scenarios, the preset trigger event may alternatively be at least one of the other preset trigger events described above. In these application scenarios, a display manner of the permission configuration prompt message may be the same or different, and the specific prompt content may correspond to the preset trigger event, and examples are not enumerated one by one herein.

It can be learned that, in the exemplary embodiment of the present disclosure, a plurality of preset trigger events are monitored, so as to avoid the following case: the permission configuration prompt message is displayed all the time during proceeding of the schedule and thus the schedule is disordered, resulting in poor schedule experience of the user. Alternatively, when it is detected that the number of the schedule attendees is greater than or equal to the preset number, the user may be reminded in a timely manner to configure the current schedule permission. This reduces schedule risks, and avoids the occurrence of schedule disorder caused by untimely configuration of the schedule permission. Alternatively, when it is detected that the attendee with the preset identity is present among the schedule attendees, the user may be reminded in a timely manner to increase a security level of the schedule, to ensure the privacy of the schedule content and reduce a risk of schedule content leakage. Alternatively, when it is detected that the schedule attribute is the preset schedule attribute, the user may be reminded in a timely manner to manage the schedule permission, thereby ensuring the schedule order and reducing schedule risks. Alternatively, when it is detected that the permission state does not match the recommended permission configuration policy, the user may be reminded in a timely manner to perform permission configuration such that the permission state of the schedule permission matches the recommended permission configuration policy, to avoid the occurrence of events that threaten the schedule security, thereby improving the efficiency of schedule order management.

In a possible implementation, the permission configuration prompt message in the exemplary embodiment of the present disclosure may be generated by the client or may be delivered by the server.

When the permission configuration prompt message is permission configuration information generated by the client, the client may detect a preset trigger event and may generate a permission configuration prompt message to prompt the user to perform permission configuration in a timely manner.

When the permission configuration prompt message is permission configuration information delivered by the server, if the client detects a preset trigger event, the client receives a permission configuration prompt message from the server. For example, the client may send a message request instruction to the server, where the message request instruction is used to request the server to send the permission configuration prompt message. The server may deliver a permission configuration prompt message to the client based on the message request. For another example, the server may monitor a preset trigger event in real time, and deliver a permission configuration prompt message to the client when the preset trigger event occurs.

Exemplarily, the permission configuration prompt message in the exemplary embodiment of the present disclosure may further include a schedule security hazard message, where the schedule security hazard message is used to indicate a potential security hazard during proceeding of the schedule. The user may configure a schedule permission with reference to the permission configuration prompt message. With the configured schedule permission, the potential security hazard during proceeding of the schedule can be dismissed, the schedule security can be enhanced, and unnecessary interference can be avoided, thereby improving the efficiency of schedule order management.

In practical application, when a client interface displays a permission configuration prompt message, the user may open a permission configuration interface to configure a schedule permission. In this case, the client may be a multimedia meeting terminal or a control terminal that is used to control a multimedia meeting. Correspondingly, the client interface may be a multimedia meeting interface, or a control terminal interface that is used to control a multimedia meeting. The permission configuration interface may come from the client interface in a schedule creation period, or may come from the client interface in a schedule proceeding period.

Regardless of whether the permission configuration interface is the multimedia meeting interface or the control terminal interface that is used to control the multimedia meeting, a permission configuration entry for the permission configuration interface may be set in a security settings component, or in a friend list component, or in other components of a display interface, or in the permission configuration prompt message. When the permission configuration entry for the permission configuration interface is set in the permission configuration prompt message, the permission configuration prompt message may further include a permission configuration entry, and the permission configuration entry may be used to provide an entry for the permission configuration interface. The client may display the permission configuration interface in response to a click operation for the permission configuration entry.

Exemplarily, the method in the exemplary embodiment of the present disclosure may further include: dismissing the permission configuration prompt message in response to a dismissing operation for the permission configuration prompt message. The dismissing operation may be at least one of the opening operation for the permission configuration interface, a canceling operation for the schedule, a confirmation operation for the permission configuration prompt message, and a new schedule creation operation.

When the user performs the opening operation for the permission configuration interface, it means that the user has received the permission configuration prompt message, and starts to configure the schedule permission. In this case, the permission configuration prompt message may be dismissed. When the user performs the confirmation operation for the permission configuration prompt message, it means that the user has confirmed the permission configuration prompt message. In this case, the permission configuration prompt message is dismissed. When the user performs the canceling operation for the schedule, it means that the schedule has been canceled, and it is unnecessary to continue to configure the schedule permission of the schedule. In this case, the permission configuration prompt message is dismissed. When the user performs the new schedule creation operation, it means that the schedule has been configured. In this case, the permission configuration prompt message is dismissed. As for the above dismissing operation for the permission configuration prompt message performed by the user, the client may dismiss the permission configuration prompt message in response to the dismissing operation for the permission configuration prompt message, to avoid the following case: the permission configuration prompt message is displayed in the display interface all the time, occupying the space of the display interface and degrading the user experience.

To facilitate the understanding of an implementation process of the method in the exemplary embodiment of the present disclosure, the implementation process of the method in the exemplary embodiment of the present disclosure is described below in conjunction with the accompanying drawings. It should be understood that the following implementation process is intended merely for explanation and not restrictive.

In a schedule creation stage, when a permission configuration prompt message is generated by the client, as shown in FIG. 3A, an entry for a permission configuration interface may be set in the permission configuration prompt message, and the user may trigger “Go to settings” (for example, on a mobile terminal, “Go to settings” may be triggered through touching) to enter the permission configuration interface, or click on “Meeting settings” to enter the permission configuration interface. If it is unnecessary to perform permission configuration, the user may trigger “I got it”.

As shown in FIG. 3B, the user may trigger “Go to settings” to enter a permission configuration interface, or click on “Security” to enter a permission configuration interface, or click on “Settings” to enter a permission configuration interface. If it is unnecessary to perform permission configuration, the user may trigger “I got it” or disable the component.

FIG. 3C is a schematic diagram of a schedule creation page with a permission configuration prompt message dismissed, according to an exemplary embodiment of the present disclosure. As shown in FIG. 3C, when the user triggers “Go to settings”, “meeting settings”, or “I got it”, a permission configuration prompt message in a schedule creation page is dismissed.

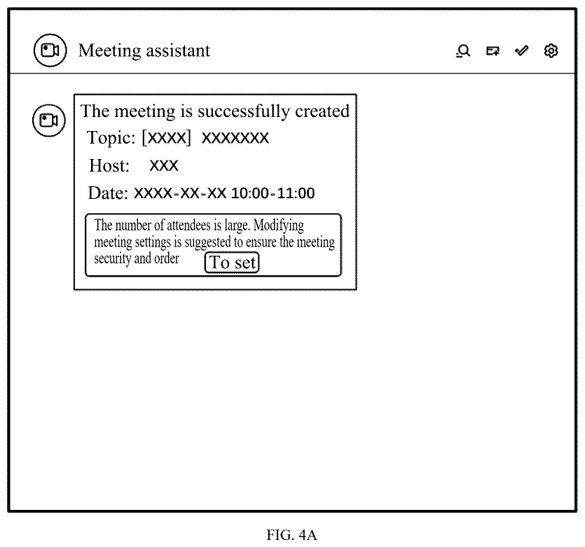

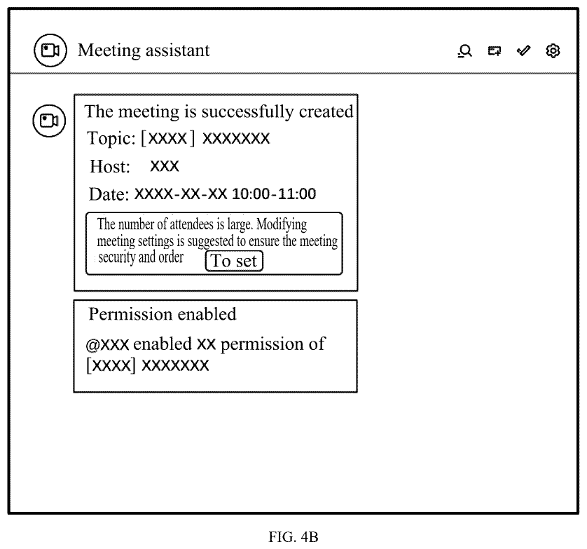

After a schedule is created and before the schedule starts, when the permission configuration prompt message is delivered by the server, FIG. 4A is a schematic diagram of a schedule creation notification according to an exemplary embodiment of the present disclosure, and FIG. 4B is a schematic diagram of a Permission Enabled notification according to an exemplary embodiment of the present disclosure. As shown in FIG. 4A, after the schedule is created, the client sends schedule editing information to the server. The server may detect, based on the schedule editing information, whether a preset trigger event occurs. When detecting the preset trigger event, the server sends a permission configuration prompt message to the client. A meeting assistant of the client may receive the permission configuration prompt message. For example, a notification indicating that a meeting is successfully created may be sent to the client in the form of a notification, to remind the user to perform permission configuration. An entry for a permission configuration interface may alternatively be set in the notification indicating that the meeting is successfully created. The user may trigger “Go to settings” to enter the permission configuration interface, or may click on a gear-like component in the upper right corner (representing “Meeting settings”) to enter the permission configuration interface to perform permission configuration. As shown in FIG. 4B, after the user sets a permission, the meeting assistant of the client may receive a “Permission Enabled” notification synchronously sent by the server.

During proceeding of the schedule, regardless of whether the permission configuration prompt message is generated by the client, or delivered by the server, a display manner of the permission configuration prompt message in a schedule interface of the client may be the same. FIG. 5 is a schematic diagram of a display manner of a permission configuration prompt message in a display interface according to an exemplary embodiment of the present disclosure. As shown in FIG. 5, when a preset trigger event is detected, a permission configuration prompt message may be displayed in the upper part of a display interface, for example, “The current number of attendees is large. Restricting the speaking permission and the sharing permission is suggested to ensure the meeting order”. The permission configuration prompt message may further include an entry (such as “To Restrict ”) for a permission configuration interface. The user may trigger “To Restrict” to enter a permission configuration interface, or may trigger “Security” in the lower part of the display interface to enter a permission configuration interface, or may click on a triangle-up component on the right side of each type of component (Microphone, Camera, Chat, Share, Record or Emoticons) in the lower part of the display interface to enter a corresponding schedule permission configuration interface, or may click on a schedule attendee list in the lower part of the display interface to enter a permission configuration interface.

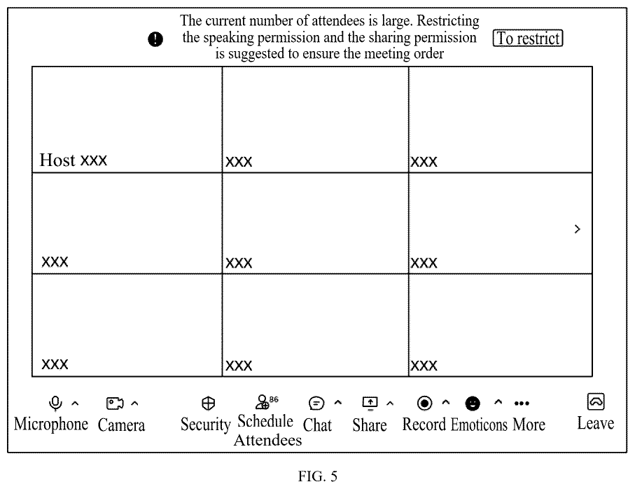

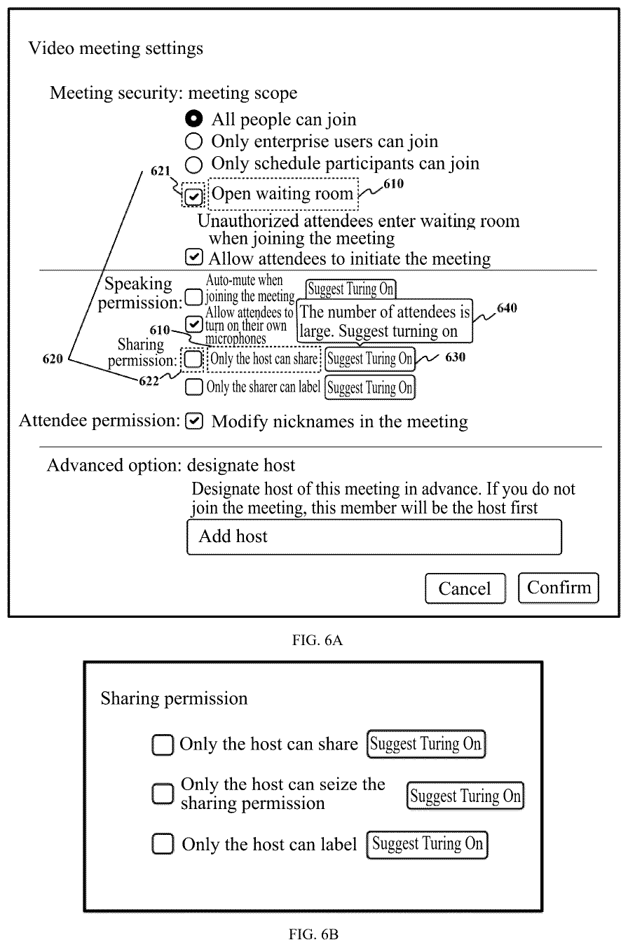

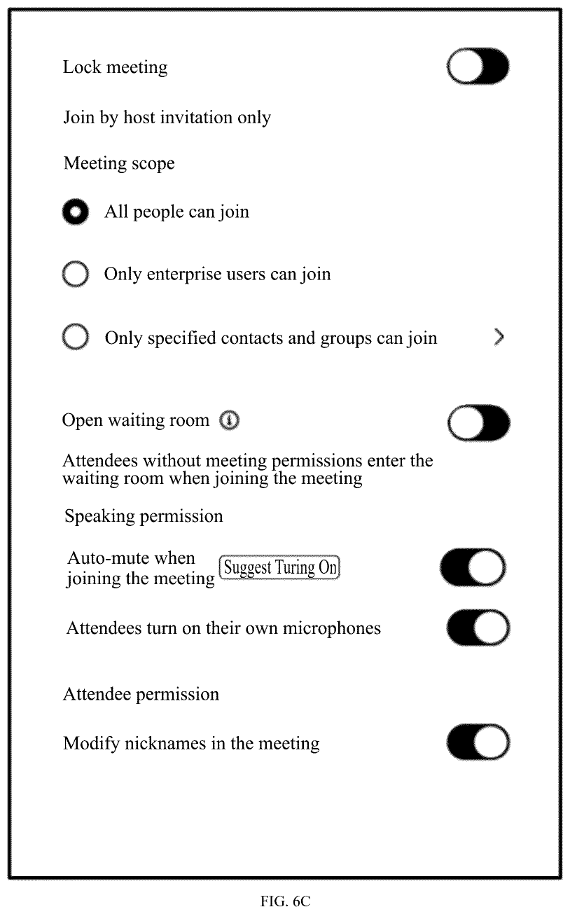

Exemplarily, the user may enter a first permission configuration interface shown in FIG. 6A through a permission configuration interface entry included in a permission configuration prompt message displayed in the schedule interface of the client, or through the “Security” component. The user may also expand a second permission configuration interface shown in FIG. 6B by clicking on the triangle-up component on the right side of each type of schedule permission component in the lower part of the schedule interface, for example, by clicking on the triangle-up component on the right side of a “Schedule” component in the lower part of the schedule interface. The user may also enter a third permission configuration interface shown in FIG. 6C by touching the permission configuration interface entry included in the permission configuration prompt message displayed in the schedule interface of the mobile terminal, the “Security” component or the schedule attendee list settings.

It can be seen from FIG. 6A to FIG. 6C that the method in the exemplary embodiment of the present disclosure may further include: displaying a schedule permission configuration item in response to an opening operation for a configuration interface for the schedule permission. There may be one or more schedule permission configuration items, which is determined based on an actual application scenario. Each schedule permission configuration item may include a schedule permission and a schedule permission state. The permission state of the schedule permission is displayed at each schedule permission. The permission state may be represented by a permission state identifier. The permission state identifier is used to represent that the permission state of the schedule permission is on or off.

If the permission state of the schedule permission does not match a recommended permission state, corresponding recommended permission configuration information is displayed. The recommended permission configuration information is used to instruct the user to adjust the permission state of the schedule permission to the recommended permission state. A display location of the recommended permission configuration information may be a display location of the corresponding schedule permission, or may be another location of the permission configuration interface, which is specifically determined based on an actual scenario and is not limited herein. If the permission state of the schedule permission matches the recommended permission state, it is unnecessary to display the corresponding recommended permission configuration information, and the permission state of the schedule permission can ensure the schedule order and the schedule security.

The recommended permission configuration information may include a plurality of recommended permission state identifiers. Each recommended permission state identifier is used to indicate the recommended permission state of the corresponding schedule permission. For example, the recommended permission state identifier may be a “Suggest Turning On” identifier and a “Suggest Turning Off” identifier. If the “Suggest Turning On” identifier is displayed for the schedule permission, the recommended permission state of the schedule permission is a Permission Enabled state. If the “Suggest Turning Off” identifier is displayed for the schedule permission, the recommended permission state of the schedule permission is a Permission Disabled state.

On this basis, the method in the exemplary embodiment of the present disclosure may further include: displaying a security prompt in response to an operation for a recommended permission state identifier. The operation for the recommended permission state identifier may include one of an operation of clicking on a recommended permission state identifier and an operation of hovering a mouse over a recommended permission state identifier. When the operation for the recommended permission state identifier is performed, the security prompt is displayed in the display interface to remind the user of a potential security hazard during proceeding of the schedule under a current permission state. An operation process of permission configuration is described below by taking FIG. 6A as an example.

As shown in FIG. 6A, when a permission configuration interface is entered through “To Restrict” or “Security” in the lower part of the display interface in FIG. 5, schedule permission configuration items, including a total of ten schedule permissions 610 and their corresponding schedule permission states, are displayed in the permission configuration interface. The ten schedule permissions 610 may be classified into meeting security, speaking permission, sharing permission, and attendee permission by type. A permission state of each schedule permission 610 may be indicated by whether a checkbox of the corresponding schedule permission is checked. For example, a checkbox 621 of “Open Waiting Room” is checked, indicating that the permission state of the schedule permission is on. A checkbox 622 of “Only the host can share” is not checked, indicating that the permission state of the schedule permission is off.

A recommended permission state identifier 630 is displayed at “Only the host can share”, for example, a “Suggest Turning On” identifier may be displayed at the end of “Only the host can share”, and is used to instruct the user to adjust the permission state of “Only the host can share” to be on. When the user clicks on the recommended permission state identifier 630 or the mouse is hovered over the recommended permission state identifier 630, a security prompt 640 is displayed at the recommended permission state identifier 630, for example, “The number of attendees is large. Suggest turning on”. When the recommended permission state of “Only the host can share” is on, and the checkbox 622 of “Only the host can share” is not checked, the user may consider that the permission state of “Only the host can share” does not match the recommended permission state. Therefore, the user may modify the permission state of “Only the host can share” to be on by checking the checkbox 622 of “Only the host can share”, thereby ensuring that the modified permission state of the schedule permission 610 can meet the permission recommendation, and ensuring the schedule order and the schedule security.

It should be noted that a schedule permission configuration operation of the schedule client is the same as a schedule permission configuration operation of the schedule control terminal in terms of process and principle. Opening manners of permission configuration pages are the same, and only layouts of the permission configuration pages have slight difference, which is not a focus of the present disclosure. When a schedule permission configuration operation is performed on the schedule control terminal, the user may also enter the third permission configuration interface shown in FIG. 6C through a “Settings” component in a schedule control terminal interface. For specific content of this step, reference may be made to the above content, and details are not described herein again.

It can be learned that, according to one or more of the technical solutions provided in the exemplary embodiments of the present disclosure, the permission configuration prompt message may be displayed when the preset trigger event is detected. The displayed permission configuration prompt message may remind the user in a timely manner to configure the current schedule permission. On this basis, the current schedule permission is configured in response to a configuration operation for the current schedule permission. It can be learned that, according to the method in the exemplary embodiment of the present disclosure, when the preset trigger event is detected, the user may be reminded in a timely manner to configure the schedule permission, thereby improving the efficiency of schedule management, and avoiding the occurrence of schedule disorder caused by untimely configuration of the schedule permission.

When the configuration operation for the schedule permission is performed on the server, the schedule permission configuring method provided in the exemplary embodiment of the present disclosure may be interactively performed by the client and the server. By taking an example in which the client and the server separately serve as the execution entity, the following embodiments describe the method in the exemplary embodiment of the present disclosure in an interactive manner in conjunction with the accompanying drawings.

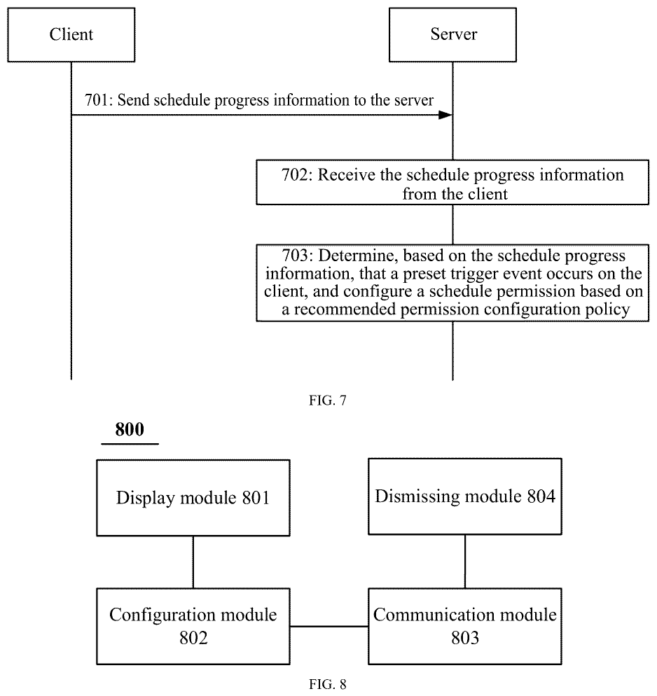

FIG. 7 is another exemplary flowchart of a schedule permission configuring method according to an exemplary embodiment of the present disclosure. As shown in FIG. 7, the schedule permission configuring method in the exemplary embodiment of the present disclosure may include:

Step 701: A client sends schedule progress information to a server. The schedule progress information may include schedule editing information or schedule dynamic information.

When the schedule progress information includes the schedule editing information, the client may send the schedule progress information to the server after a schedule is created but before the schedule starts. The schedule editing information may include at least the number of schedule attendees to participate in the schedule, identities of the schedule attendees, a schedule attribute, and a permission state of a schedule permission, and certainly may further include other information, such as a start time and an end time of the schedule, and a schedule host.

When the schedule progress information includes the schedule dynamic information, the client may upload the schedule dynamic information to the server in real time during proceeding of the schedule. In this case, the schedule dynamic information may include at least the number of currently online schedule attendees, identities of the schedule attendees, a schedule attribute, a permission state of a schedule permission, and the number of times for permission configuration.

Step 702: the Server Receives the Schedule Progress Information From the Client.

Step 703: The server determines, based on the schedule progress information, that a preset trigger event occurs on the client, and configures a schedule permission based on a recommended permission configuration policy. For a manner in which the server determines that the preset trigger event occurs on the client, reference may be made to the above description. The preset trigger event includes at least one of the following: the number of schedule attendees is greater than or equal to a preset number, an attendee with a preset identity is present among the schedule attendees, a schedule attribute is a preset schedule attribute, a permission state does not match a recommended permission configuration policy, and the number of display times of the permission configuration prompt message is less than a preset number of times. The recommended permission configuration policy satisfies the following: The permission state of the schedule permission satisfies a recommended permission state, where the recommended permission state is used to manage the schedule permission.

When the schedule progress information includes the schedule editing information, and the server may determine, based on the schedule editing information, that a preset trigger event occurs, the schedule permission is automatically configured based on the recommended permission configuration policy, and a “Permission Enabled” notification is sent to a meeting assistant of the client in the form of a notification after the schedule permission is configured. For details, reference may be made to FIG. 4B.

When the schedule progress information includes the schedule dynamic information, the server may determine, based on real-time schedule dynamic information sent by the client, whether a preset trigger event occurs on the client. When it is determined that the preset trigger event occurs on the client, the schedule permission is automatically configured based on a recommended permission configuration policy, a “Permission configuration” notification is sent to a meeting assistant of the client in the form of a notification after the schedule permission is configured (for details, reference may be made to FIG. 4A and FIG. 4B.), and a prompt message that permission configuration is completed may alternatively be displayed in the form of a pop-up window in a schedule interface, to inform the user who the schedule permission has been configured, such that the user learns of the configuration status of the schedule permission in a timely manner.

It can be learned that, according to the exemplary embodiment of the present disclosure, the server may monitor the schedule progress information of the client. When detecting that the preset trigger event occurs on the client, the server configures the schedule permission based on the recommended permission configuration policy, and sends the configured schedule permission information to the client, such that the client can manage the schedule based on the configured schedule permission information, thereby implementing automatic schedule permission configuration on the server, and reducing operation steps of schedule configuration on the client, and meanwhile, avoiding displaying the permission configuration prompt message during proceeding of the schedule and thus avoiding interrupting the schedule process of the user. This improves the efficiency of schedule order management and ensures the schedule security, thereby improving the schedule experience of the user.

To implement the above functions, the client or the server in the exemplary embodiment of the present disclosure includes corresponding hardware structures and/or software modules that perform various functions. Those skilled in the art may be easily aware that units and algorithm steps of various examples described in conjunction with the embodiments disclosed herein may be implemented by hardware or a combination of hardware and computer software in the present disclosure. Whether a specific function is performed by hardware or hardware driven by computer software depends on the specific application and design constraints of the technical solution. Those skilled in the art can implement the described functions by using different methods for each particular application, but such implementation should not be considered as going beyond the scope of the present disclosure.

In the embodiments of the present disclosure, the client or the server may be divided into functional units based on the above method examples. For example, each functional module may be obtained through division based on each corresponding function, or two or more functions may be integrated into one processing module. The above integrated module may be implemented in the form of hardware, or may be implemented in the form of a software functional module. It should be noted that the division of modules in the embodiments of the present disclosure is illustrative and is merely logical function division, and there may be other division methods in actual implementation.

In the case in which each functional module is obtained through division based on each corresponding function, an exemplary embodiment of the present disclosure provides a schedule permission configuring apparatus. FIG. 8 is a schematic block diagram of modules of a schedule permission configuring apparatus according to an exemplary embodiment of the present disclosure. As shown in FIG. 8, the schedule permission configuring apparatus 800 includes:
a display module 801 configured to display a permission configuration prompt message if a preset trigger event is detected; and
a configuration module 802 configured to configure a schedule permission in response to an operation of performing schedule permission configuration.

In a possible implementation, the schedule permission configuring apparatus 800 further includes: a communication module 803 configured to send a message request instruction to a server, where the message request instruction is used to request the server to send the permission configuration prompt message; and receive the permission configuration prompt message from the server if the preset trigger event is detected.

In a possible implementation, the preset trigger event includes at least one of the following: the number of schedule attendees is greater than or equal to a preset number, an attendee with a preset identity is present among the schedule attendees, a schedule attribute is a preset schedule attribute, a permission state does not match a recommended permission configuration policy, and the number of display times of the permission configuration prompt message is less than a preset number of times.

In a possible implementation, the preset trigger event supports configuration and update.

In a possible implementation, the display module 801 is further configured to display a schedule permission configuration item in response to an opening operation for a permission configuration interface for a schedule.

In a possible implementation, the permission configuration interface comes from a client interface in a schedule creation period. The permission configuration interface comes from a client interface in a schedule proceeding period.

In a possible implementation, the client interface in the schedule proceeding period includes a multimedia meeting interface, or a control terminal interface that is used to control a multimedia meeting.

In a possible implementation, the permission configuration prompt message further includes a permission configuration entry.

In a possible implementation, the display module 801 is configured to display the permission configuration prompt message in a client interface of a first user having a schedule configuration permission if the preset trigger event is detected, such that the first user and/or a second user designated by the first user configures the schedule permission.

In a possible implementation, the display module 801 is further configured to display corresponding recommended permission configuration information if a permission state of the schedule permission does not match a recommended permission state, where the recommended permission configuration information is used to instruct the user to adjust the permission state of the schedule permission to the recommended permission state.

In a possible implementation, the recommended permission configuration information includes a plurality of recommended permission state identifiers. Each recommended permission state identifier is used to indicate a recommended permission state of a corresponding schedule permission. The display module 801 is further configured to display a security prompt in response to an operation for the recommended permission state identifier.

In a possible implementation, the schedule permission configuring apparatus 800 further includes: a dismissing module 804 configured to dismiss the permission configuration prompt message in response to a dismissing operation for the permission configuration prompt message, where the dismissing operation is at least one of the opening operation for the permission configuration interface, a canceling operation for the schedule, a confirmation operation for the permission configuration prompt message, and a new schedule creation operation.

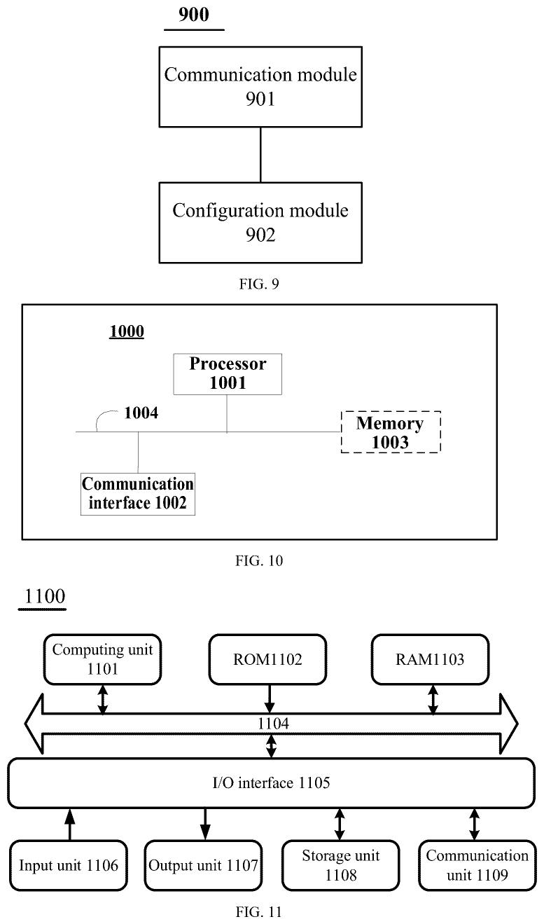

An exemplary embodiment of the present disclosure further provides another schedule permission configuring apparatus. FIG. 9 is a schematic block diagram of modules of a schedule permission configuring apparatus according to an exemplary embodiment of the present disclosure. As shown in FIG. 9, the schedule permission configuring apparatus 900 includes:
a communication module 901 configured to receive schedule progress information from a client; and
a configuration module 902 configured to determine, based on the schedule progress information, that a preset trigger event occurs on the client, and configure a schedule permission based on a recommended permission configuration policy.

In a possible implementation, the schedule progress information includes schedule editing information or schedule dynamic information.

In a possible implementation, the preset trigger event includes at least one of the following: the number of schedule attendees is greater than or equal to a preset number, an attendee with a preset identity is present among the schedule attendees, a schedule attribute is a preset schedule attribute, a permission state does not match a recommended permission configuration policy, and the number of display times of the permission configuration prompt message is less than a preset number of times.

FIG. 10 is a schematic block diagram of a chip according to an exemplary embodiment of the present disclosure. As shown in FIG. 10, the chip 1000 includes one or more (including two) processors 1001 and a communication interface 1002. The communication interface 1002 may support a server in performing data transceiving steps in the above method, and the processor 1001 may support the server in performing data processing steps in the above method.

Optionally, as shown in FIG. 10, the chip 1000 further includes a memory 1003. The memory 1003 may include a read-only memory and a random access memory, and provide operating instructions and data to the processor. A part of the memory may further include a non-volatile random access memory (NVRAM).

In some implementations, as shown in FIG. 10, the processor 1001 performs a corresponding operation by calling an operation instruction stored in the memory (the operation instruction may be stored in an operating system). The processor 1001 controls a processing operation of any one of terminal devices. The processor may also be referred to as a central processing unit (CPU). The memory 1003 may include a read-only memory and a random access memory, and provide instructions and data to the processor 1001. A part of the memory 1003 may further include an NVRAM. For example, in an application, the memory, the communication interface, and the memory are coupled together by using a bus system. In addition to a data bus, the bus system may further include a power bus, a control bus, a status signal bus, and the like. However, for the sake of clarity, the various buses are labeled as a bus system 1004 in FIG. 10.

The method disclosed in the above embodiment of the present disclosure may be applied to a processor, or be implemented by a processor. The processor may be an integrated circuit chip with a signal processing capability. During implementation, the steps in the above method may be completed by an integrated logic circuit of hardware in the processor or an instruction in the form of software. The above processor may be a general-purpose processor, a digital signal processor (DSP), an application specific integrated circuit (ASIC), a field-programmable gate array (FPGA) or another programmable logic device, a discrete gate or transistor logic device, or a discrete hardware component. The methods, steps, and logic block diagrams disclosed in the embodiments of the present disclosure may be implemented or performed. The general-purpose processor may be a microprocessor, or the processor may be any conventional processor or the like. The steps of the method disclosed in combination with the embodiments of the present disclosure may be directly embodied as being completed by a hardware decoding processor, or by a combination of hardware in the decoding processor and a software module. The software module may be located in a mature storage medium in the art, such as a random access memory, a flash memory, a read-only memory, a programmable read-only memory, an electrically erasable programmable memory, or a register. The storage medium is located in a memory. The processor reads information in the memory, and completes the steps in the above method in combination with the hardware of the processor.

An exemplary embodiment of the present disclosure further provides an electronic device, including: at least one processor; and a memory communicatively connected to the at least one processor. The memory stores a computer program that is executable by the at least one processor, and the computer program, when executed by the at least one processor, is used to cause the electronic device to perform the method according to the embodiment of the present disclosure.

An exemplary embodiment of the present disclosure further provides a non-transitory computer-readable storage medium storing a computer program, where the computer program, when executed by a processor of a computer, is used to cause the computer to perform the method according to the embodiment of the present disclosure.

An exemplary embodiment of the present disclosure further provides a computer program product including a computer program, where the computer program, when executed by a processor of a computer, is used to cause the computer to perform the method according to the embodiment of the present disclosure.

With reference to FIG. 11, a block diagram of a structure of an electronic device 1100 that may serve as a server or a client in the present disclosure is described below. The electronic device is an example of a hardware device that may be applied to various aspects of the present disclosure. The electronic device is intended to represent various forms of digital electronic computer devices, such as laptop computers, desktop computers, workbenches, personal digital assistants, servers, blade servers, mainframe computers, and other suitable computers. The electronic device may alternatively represent various forms of mobile devices, such as personal digital processing, cellular telephones, smartphones, wearable devices, and other similar computing devices. Components, their connections and relationships, and their functions shown herein are only examples, and are not intended to limit the implementation of the present disclosure described and/or claimed herein.

As shown in FIG. 11, the electronic device 1100 includes a computing unit 1101 that may perform a variety of appropriate actions and processing in accordance with a computer program stored in a read-only memory (ROM) 1102 or a computer program loaded from a storage unit 1108 into a random access memory (RAM) 1103. The RAM 1103 may further store various programs and data required for the operation of the device 1100. The computing unit 1101, the ROM 1102, and the RAM 1103 are connected to each other through a bus 1104. An input/output (I/O) interface 1105 is also connected to the bus 1104.

A plurality of components in the electronic device 1100 are connected to the I/O interface 1105, where the components include: an input unit 1106, an output unit 1107, a storage unit 1108, and a communication unit 1109. The input unit 1106 may be any type of device that can input information to the electronic device 1100, and the input unit 1106 may receive input numeric or character information, and generate key signal inputs related to user settings and/or function control of the electronic device. The output unit 1107 may be any type of device that can present information, and may include but is not limited to a display, a speaker, a video/audio output terminal, a vibrator, and/or a printer. The storage unit 1108 may include but is not limited to a magnetic disk and an optical disc. The communication unit 1109 allows the electronic device 1100 to exchange information/data with other devices through a computer network, such as the Internet, and/or various telecommunication networks, and may include but is not limited to a modem, a network adapter, an infrared communication device, a wireless communication transceiver, and/or a chipset, such as a Bluetooth ™M device, a WiFi device, a WiMax device, a cellular communication device, and/or analogues.

As shown in FIG. 11, the computing unit 1101 may be a variety of general-purpose and/or special-purpose processing components that have processing and computing capabilities. Some examples of the computing unit 1101 include but are not limited to a central processing unit (CPU), a graphics processing unit (GPU), various dedicated artificial intelligence (AI) computing chips, various computing units running machine learning model algorithms, digital signal processors (DSPs), as well as any appropriate processor, controller, microcontroller, and the like. The computing unit 1101 performs the various methods and processing described above. For example, in some embodiments, the method in the exemplary embodiment of the present disclosure may be implemented as a computer software program that is tangibly embodied in a machine-readable medium, such as the storage unit 1108. In some embodiments, some or all of the computer programs may be loaded into and/or installed onto the electronic device 1100 via the ROM 1102 and/or the communication unit 1109. In some embodiment, the computing unit 1101 may be configured to perform the method in any other appropriate manner (for example, by means of firmware).

Program code used to implement the method of the present disclosure may be written in any combination of one or more programming languages. The program code may be provided to a processor or a controller of a general-purpose computer, a special-purpose computer, or another programmable data processing apparatus, such that when the program code is executed by the processor or the controller, functions/operations specified in the flowcharts and/or the block diagrams are implemented. The program code may be completely or partially executed on a machine, or may be executed as an independent software package partially on a machine and partially on a remote machine, or completely on a remote machine or a server.

In the context of the present disclosure, a machine-readable medium may be a tangible medium that may contain or store a program used by or in combination with an instruction execution system, apparatus, or device. The machine-readable medium may be a machine-readable signal medium or a machine-readable storage medium. The machine-readable medium may include, but is not limited to, an electronic, magnetic, optical, electromagnetic, infrared, or semiconductor system, apparatus, or device, or any suitable combination thereof. More specific examples of the machine-readable storage medium may include an electrical connection based on one or more wires, a portable computer disk, a hard disk, a random access memory (RAM), a read-only memory (ROM), an erasable programmable read-only memory (EPROM) (or a flash memory), an optic fiber, a portable compact disc read-only memory (CD-ROM), an optical storage device, a magnetic storage device, or any suitable combination thereof.

As used in the present disclosure, the terms “machine-readable medium” and “computer-readable medium” refer to any computer program product, device, and/or apparatus (for example, magnetic disk, optical disc, memory, programmable logic device (PLD)) that is used to provide machine instructions and/or data to a programmable processor, including a machine-readable medium that receives machine instructions serving as machine-readable signals. The term “machine-readable signal” refers to any signal that is used to provide machine instructions and/or data to a programmable processor.

To provide interaction with a user, the systems and technologies described herein may be implemented on a computer. The computer is provided with: a display apparatus (for example, a cathode ray tube (CRT) or a liquid crystal display (LCD) monitor) used to display information to a user; and a keyboard and pointing apparatus (for example, a mouse or trackball) through which the user can provide input to the computer. Other kinds of apparatuses may also be used to provide interaction with a user. For example, feedback provided to the user may be any form of sensory feedback (for example, visual feedback, auditory feedback, or tactile feedback); and input from the user may be received in any form (including sound input, voice input, or tactile input).

The systems and technologies described herein may be implemented in a computing system (for example, serving as a data server) that includes a background component, or a computing system (for example, an application server) that includes a middleware component, or a computing system that includes a front-end component (for example, a user computer having a graphical user interface or a web browser through which a user can interact with implementations of the systems and technologies described herein), or a computing system that includes any combination of such a background component, a middleware component or a front-end component. The components of the system may be interconnected through digital data communication (for example, a communication network) in any form or of any medium. Examples of communication networks include: local area networks (LANs), wide area networks (WANs), and the Internet.

A computer system may include a client and a server. The client and the server are generally far away from each other and usually interact with each other through a communication network. A relationship between the client and the server is generated by computer programs running on corresponding computers and having a client-server relationship with each other.

The above embodiment may be completely or partially implemented by software, hardware, firmware, or any combination thereof. When implemented by software, all or some of the embodiments may be implemented in the form of the computer program product. The computer program product includes one or more computer programs or instructions. When the computer programs or instructions are loaded and executed on a computer, the procedures or functions described in the embodiment of the present disclosure are completely or partially executed. The computer may be a general-purpose computer, a special-purpose computer, a computer network, a terminal, user equipment, or another programmable apparatus. The computer programs or instructions may be stored in the computer-readable storage medium, or may be transmitted from one computer-readable storage medium to another computer-readable storage medium. For example, the computer programs or instructions may be transmitted from one website, computer, server, or data center to another website, computer, server, or data center in a wired or wireless manner. The computer-readable storage medium may be any usable medium accessible by the computer, or may be a data storage device, such as a server or a data center, that integrates one or more usable media. The usable medium may be a magnetic medium, such as a floppy disk, a hard disk, and a magnetic tape, or may be an optical medium, such as a digital video disc (DVD), or may be a semiconductor medium, such as a solid-state drive (SSD).

Although the present disclosure has been described in conjunction with specific features and embodiments thereof, it will be apparent that various modifications and combinations may be made thereto without departing from the spirit and scope of the present disclosure. Correspondingly, the specification and the accompanying drawings are merely exemplary illustrations of the present disclosure as defined by the appended claims, and are regarded as covering any and all modifications, variations, combinations or equivalents within the scope of the present disclosure. Clearly, those skilled in the art may make various modifications and variations to the present disclosure without departing from the spirit and scope of the present disclosure. Therefore, if these modifications and variations of the present disclosure fall within the scope of the claims of the present disclosure and equivalent technologies thereof, the present disclosure is also intended to include these modifications and variations.

1. A schedule permission configuring method, wherein the method comprises:
displaying a permission configuration prompt message in response to detecting a preset trigger event; and
configuring a schedule permission in response to a configuration operation for the schedule permission.

2. The method according to claim 1, wherein the method further comprises:
sending a message request instruction to a server, wherein the message request instruction is configured to request the server to send the permission configuration prompt message; and
receiving the permission configuration prompt message from the server in response to detecting the preset trigger event.

3. The method according to claim 1, wherein the preset trigger event comprises at least one of the following: a number of schedule attendees is greater than or equal to a preset number, an attendee with a preset identity is present among the schedule attendees, a schedule attribute is a preset schedule attribute, a permission state does not match a recommended permission configuration policy, and a number of display times of the permission configuration prompt message is less than a preset number of times.

4. The method according to claim 1, wherein the preset trigger event supports configuration and update.

5. The method according to claim 1, wherein the method further comprises:
displaying a schedule permission configuration item in response to an opening operation for a configuration interface for the schedule permission.

6. The method according to claim 5, wherein the permission configuration interface is a client interface in a schedule creation period; or
the permission configuration interface is a client interface in a schedule proceeding period.

7. The method according to claim 6, wherein the client interface in the schedule proceeding period comprises a multimedia meeting interface, or a control terminal interface that is configured to control a multimedia meeting.

8. The method according to claim 1, wherein the permission configuration prompt message further comprises a permission configuration entry.

9. The method according to claim 1, wherein the displaying a permission configuration prompt message in response to detecting a preset trigger event comprises:
displaying the permission configuration prompt message in a client interface of a first user having a schedule configuration permission in response to detecting the preset trigger event, such that at least one of the first user and a second user designated by the first user configures the schedule permission.

10. The method according to claim 1, wherein the method further comprises:
displaying corresponding recommended permission configuration information in response that a permission state of the schedule permission does not match a recommended permission state, wherein the recommended permission configuration information is configured to instruct a user to adjust the permission state of the schedule permission to the recommended permission state.

11. The method according to claim 10, wherein the recommended permission configuration information comprises a plurality of recommended permission state identifiers, each recommended permission state identifier is configured to indicate a recommended permission state of a corresponding schedule permission, and the method further comprises:
displaying a security prompt in response to an operation for the recommended permission state identifier.

12. The method according to claim 10, wherein the method further comprises:
stopping displaying the permission configuration prompt message in response to a dismissing operation for the permission configuration prompt message, wherein the dismissing operation is at least one of an opening operation for the permission configuration interface, a canceling operation for the schedule, a confirmation operation for the permission configuration prompt message, and a new schedule creation operation.

13. A schedule permission configuring method, wherein the method comprises:
receiving schedule progress information from a client; and
determining, based on the schedule progress information, that a preset trigger event occurs on the client, and configuring a schedule permission based on a recommended permission configuration policy.

14. The method according to claim 13, wherein the schedule progress information comprises schedule editing information or schedule dynamic information.

15. The method according to claim 13, wherein the preset trigger event comprises at least one of the following: a number of schedule attendees is greater than or equal to a preset number, an attendee with a preset identity is present among the schedule attendees, a schedule attribute is a preset schedule attribute, a permission state does not match the recommended permission configuration policy, and a number of display times of a permission configuration prompt message is less than a preset number of times.

16. (canceled)

17. (canceled)

18. An electronic device, comprising:
a processor; and
a memory storing a program;
wherein the program comprises instructions that, when executed by the processor, cause the processor to perform a schedule permission configuring method according to claim 1.

19. A non-transitory computer-readable storage medium storing computer instructions, wherein the computer instructions are configured to cause a computer to perform a schedule permission configuring method according to claim 1.

20. An electronic device, comprising:
a processor; and
a memory storing a program;
wherein the program comprises instructions that, when executed by the processor, cause the processor to perform a schedule permission configuring method according to claim 13.

21. A non-transitory computer-readable storage medium storing computer instructions, wherein the computer instructions are used to cause a computer to perform a schedule permission configuring method according to claim 13.
